(19) United States
(12) Patent Application Publication
(10) Pub. No.: US 2006/0155556 A1
(43) Pub. Date: Jul. 13, 2006

(54) Business method of encouraging participation in an association

(76) Inventor: Blaine Harris, Bountiful, UT (US)

Correspondence Address: Kirton & McConkie;1800 Eagle Gate Tower, 60 East South Temple, P.O. Box 45120, Salt Lake City, UT, 84111, US

(21) Appl. No.: 11/031,559

(22) Filed: Jan. 7, 2005

(51) Int. Cl. G06F 17/60

(52) U.S. Cl. 705/1

(57) ABSTRACT

The present invention relates to a business method for encouraging participation in an association of competitive entities through exclusive access to a desired product. This method is designed for use in individual industries that are dominated by small scale local businesses. Particular local businesses will be selected and offered an opportunity to join the association. Only one business in each local industry market will be allowed to join the association. In exchange for joining the association, members will be given exclusive local rights to sell a particular floral product. The floral product will be offered to association members at a lower price than they could otherwise obtain. Association members will be required to pay at least one of an initiation fee, a monthly fee, a yearly fee, a per product fee, and a percentage of sales.

### BACKGROUND

1. Field of the Invention

The present invention relates to a business method for encouraging participation in an association. More particularly, the present invention relates to a business method for encouraging participation in an association of competitive entities through exclusive access to a desired product.

2. Background

In the last ten years, large national and international companies have dominated almost all markets by providing products and services at a discounted price. However, some industries have resisted large scale company dominance. Customers within these industries have shown a preference for small operations that are locally based with which they can have a personal relationship. These industries include floral shops, wedding planners, corporate event planners, funeral planners, etc. The inherent personal nature of these businesses results in a customer's desire for personal attention from a local merchant who is familiar with the local concerns of the customer.

Various corporations have attempted to consolidate these industries but have failed. Various problems result because of the lack of unity between the businesses. For example, local businesses are forced to pay higher prices for items related to their services because they are purchased on a very small scale in relation to the industry as a whole. In addition, the prices local companies pay for items is further increased by the necessity of intermediary parties between the local company and the manufacturer/supplier. In addition to price, local companies are often not able to provide certain high end products that may only be available through bulk purchases. Therefore, for at least these reasons there is a need in these industries for a system that provides an incentive for local businesses within particular industries to associate with one another.

### SUMMARY

The present invention relates to a business method for encouraging participation in an association of competitive entities through exclusive access to a desired product. This method is designed for use in individual industries that are dominated by small scale local businesses. Particular local businesses will be selected and offered an opportunity to join the association. Only one business in each small market and only a few in larger markets will be allowed to join the association. In exchange for joining the association, members will be given exclusive local rights to sell a particular floral product. The floral product will be offered to association members at a lower price than they could otherwise obtain. Association members will be required to pay at least one of an initiation fee, a monthly fee, a yearly fee, a per product fee, and a percentage of sales. These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a flow chart in accordance with of one embodiment of the present invention.

### DETAILED DESCRIPTION OF THE PREFERRED EMBODIMENTS

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The present invention relates to a business method for encouraging participation in an association of competitive entities through exclusive access to a desired product. This method is designed for use in individual industries that are dominated by small scale local businesses. Particular local businesses will be selected and offered an opportunity to join the association. Only one business in each local industry market will be allowed to join the association. In exchange for joining the association, members will be given exclusive local rights to sell a particular floral product. The floral product will be offered to association members at a lower price than they could otherwise obtain. Association members will be required to pay at least one of an initiation fee, a monthly fee, a yearly fee, a per product fee, and a percentage of sales. While embodiments of the present invention are directed at a method of encouraging participation in an industry association, it will be appreciated that the teachings of the present invention are applicable to other areas.

As used in this specification, the following terms are defined accordingly:

“floral product” is a product that includes at least one flower. A “floral product” may also include other non-flower related products to form a kit.

“floral industry” is the retail industry of selling flowers and arrangements of flowers to the public.

“funeral industry” is the retail industry of facilitating funerals for the public.

“wedding planning industry” is the retail industry of facilitating weddings for the public.

“corporate event planning industry” is the retail industry of facilitating corporate events for corporations and businesses.

“customizable floral product” is a floral product that includes at least one customizable flower.

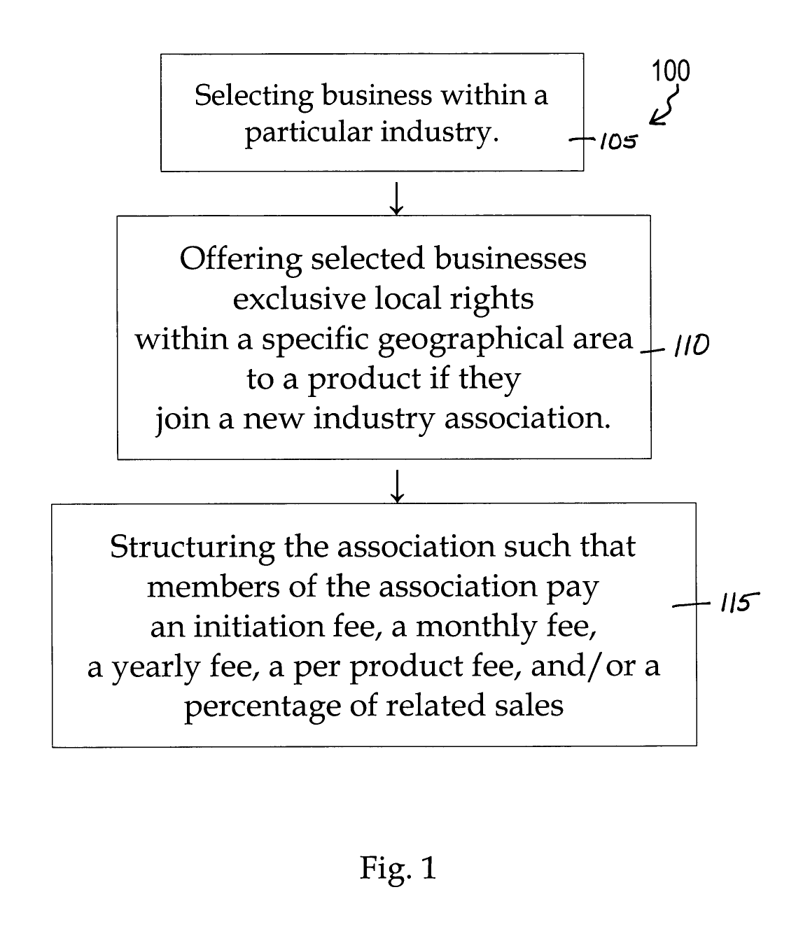

Reference is made to FIG. 1, which illustrates a flow chart in accordance with one embodiment of the present invention, designated generally at 100. The flow chart delineates the process for encouraging participation in an association of competitive entities through exclusive access to a desired product. Naturally, the process will be slightly different for different industries. For example, floral industry businesses behave differently than funeral industry businesses.

Initially, businesses are selected within a particular industry, act 105. The selected businesses are located in different local markets so there is no direct competition among the selected businesses. Various methodologies may be used to identify the selected businesses. For example, the selected businesses may be the businesses in each market that have the highest annual revenue. Alternatively, the businesses may be selected for the number of years they have been in operation or the number of employees they currently employ.

Next, the selected businesses are offered exclusive local rights to sell a particular product if they join a new industry association, act 110. Since the selected businesses in a small market are each located in discrete markets, each of the selected businesses will be given the opportunity to have a monopoly on the particular product within their local small market. Several may share a larger market. The particular product is provided to the association members via a single provider entity. For example, the particular product may include a patented customizable floral product from Speaking Roses™. The customizable floral product includes at least one customizable flower and may further include at least one other non-flower related item. The non-flower related item may be either customized or non-customized. For example, non-customized non-flower related items may include a teddy bear, candy, clothing, baskets, etc. And wherein customized non-flower related items may include any item with a customized greeting or logo printed on it.

In addition, the floral product is offered to association members at a lower price than they would otherwise pay for a similar product. The single provider entity is able to offer the floral product at a lower price to association members by dealing in bulk quantities and by ordering directly from an international supplier. Likewise, association members may also be required to purchase all flowers from the single entity provider to ensure that the single entity provider is able to continue to make bulk purchases from the direct supplier. When flowers are ordered by small businesses they are forced to pay a premium price because of their small quantity purchases and the required intermediaries between the small business and the actual supplier.

Next, the association is structured such that each member pays an initiation fee, a monthly fee, a yearly fee, product fees, and/or a percentage of related sales at 115 in FIG. 1. The fee structure and the amount of the fees may be different for different industries. In some industries it may be desirable to have a low initiation fee to entice smaller businesses but require a larger percentage of profits. Alternatively, in industries with medium sized businesses it may be advantageous to obtain a large initiation fee. A portion of the fees will be sent to the single entity provider in exchange for providing the product. The remainder of the fees will be used by the association for advertising, marketing, bulk purchases, lobbying, etc. The operations of the association relating to the use of advertising contributions will be managed by the association members. For example, the association may elect representatives and vote on how the funds in the advertising budget of the association will be allocated. Although they will not own the association, they will have a direct voice in how the advertising dollars are spent.

Each industry which this method is applied may require specific association characteristics. The floral industry will most likely require the association members have the ability to use their fees for advertising campaigns. The wedding industry will most likely require the association members have the ability to purchase wedding related items at a bulk discount. The funeral industry will also likely require the association members have the ability to purchase funeral related items at a bulk discount. The corporate event industry will likely require the association members to have the ability to use their fees for advertising and purchase corporate event related products at a bulk discount.

Thus, as discussed herein, the embodiments of the present invention embrace a business method for encouraging participation in an association. More particularly, the present invention relates to a business method for encouraging participation in an association of competitive entities through exclusive access to a desired product.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed and desired to be secured by Letters Patent is:

1. A method for encouraging participation in an association of competitive entities comprising the acts of:
selecting businesses in a particular industry, wherein the selected businesses are disposed in substantially discrete markets;
offering the selected businesses exclusive local rights to a floral product in exchange for joining a new industry association; and
structuring the association such that members pay a fee including at least one of an initiation fee, a monthly fee, a yearly fee, product fees, and a percentage of revenue.

2. The method of claim 1, wherein the particular industry is the floral industry.

3. The method of claim 1, wherein the particular industry is the funeral industry.

4. The method of claim 1, wherein the particular industry is the wedding planning industry.

5. The method of claim 1, wherein the particular industry is the corporate event planning industry.

6. The method of claim 1, wherein the act of selecting businesses in a particular industry further includes identifying the business with the largest revenues in a particular industry and a particular market.

7. The method of claim 1, wherein the exclusive local rights to a floral product are the exclusive rights to sell that floral product within the local market of a particular selected business.

8. The method of claim 1, wherein the floral product is a customizable floral product that includes at least one flower with a customized printing.

9. The method of claim 1, wherein the floral product is a customizable floral product that is offered to association members at a price lower than a particular selected business could otherwise obtain for a non-customized version of the same floral product.

10. The method of claim 1, wherein the floral product is a kit that includes at least one customized flower and at least one non-flower item.

11. The method of claim 10, wherein the at least one non-flower item is customized.

12. The method of claim 1 further includes allowing association members to purchase other industry specific items at a bulk discount.

13. The method of claim 1 further includes allowing association members to spend a portion of their fees for multi-market advertising campaigns.

14. The method of claim 1 further includes allowing association members to obtain referrals from an association headquarters.

15. The method of claim 1 further includes allowing association members to spend a portion of their fees for government lobbying.

16. A method for encouraging participation in an association of competitive floral entities comprising the acts of:
selecting floral businesses in substantially discrete markets;
offering the selected floral businesses exclusive local rights within a specific geographical market to a customizable floral product in exchange for joining a new floral industry association; and
structuring the association such that members pay a fee including at least one of an initiation fee, a monthly fee, a yearly fee, product fees, and a percentage of revenue.

17. The method of claim 16, wherein floral businesses include retail businesses that sell a variety of flowers to the public.

18. The method of claim 16, wherein the act of selecting floral businesses in a particular industry further includes identifying the business with the largest revenues in a particular industry and a particular market.

19. The method of claim 16, wherein the customizable floral product includes at least one flower with a customized printed greeting.

20. The method of claim 16, wherein the customizable floral product is offered to association members at a price lower than a particular selected floral business could otherwise obtain for a non-customized version of a similar flower.

21. The method of claim 16 further includes allowing association members to spend a portion of their fees for multi-market advertising campaigns.

22. A method for encouraging participation in an association of competitive wedding planners, comprising the acts of:
selecting wedding planner businesses in substantially discrete markets;
offering the selected wedding planner businesses exclusive local rights to a floral product in a specific geographical market in exchange for joining a new wedding planner industry association; and
structuring the association such that members pay a fee including at least one of an initiation fee, a monthly fee, a yearly fee, product fees, and a percentage of revenue.

23. The method of claim 22, wherein wedding planner businesses include retail businesses that assist in the planning and arranging of wedding ceremonies.

24. The method of claim 22, wherein the act of selecting wedding planner businesses in a particular industry further includes identifying the business with the largest revenues in a particular industry and a particular market.

25. The method of claim 22, wherein the floral product includes at least one flower with a customized printed greeting.

26. The method of claim 22, wherein the floral product is offered to association members at a price lower than a particular selected wedding planner business could otherwise obtain for a non-customized version of a similar flower.

27. The method of claim 22 further includes allowing association members to spend a portion of their fees for multi-market advertising campaigns.

28. A method for encouraging participation in an association of competitive funeral planners, comprising the acts of:
selecting funeral planner businesses in substantially discrete markets;
offering the selected funeral planner businesses exclusive local rights to a floral product in exchange for joining a new funeral planner industry association; and
structuring the association such that members pay a fee including at least one of an initiation fee, a monthly fee, a yearly fee, product fees, and a percentage of revenue.

29. The method of claim 28, wherein funeral planner businesses include retail businesses that assist in the planning and arranging of funeral ceremonies.

30. The method of claim 28, wherein the act of selecting funeral planner businesses in a particular industry further includes identifying the business with the largest revenues in a particular industry and a particular market.

31. The method of claim 28, wherein the floral product includes at least one flower with a customized printed greeting.

32. The method of claim 28, wherein the floral product is offered to association members at a price lower than a particular selected funeral planner business could otherwise obtain for a non-customized version of a similar flower.

33. The method of claim 28 further includes allowing association members to purchase other industry specific items at a bulk discount.

34. A method for encouraging participation in an association of competitive corporate event planners, comprising the acts of:
selecting corporate event planner businesses in substantially discrete markets;
offering the selected corporate event planner businesses exclusive local rights to a floral product in exchange for joining a new corporate event planner industry association; and
structuring the association such that members pay a fee including at least one of an initiation fee, a monthly fee, a yearly fee, product fees, and a percentage of revenue.

35. The method of claim 34, wherein corporate event planner businesses include retail businesses that assist in the planning and arranging of corporate events.

36. The method of claim 34, wherein the act of selecting corporate event planner businesses in a particular industry further includes identifying the business with the largest revenues in a particular industry and a particular market.

37. The method of claim 34, wherein the floral product includes at least one flower with a customized printed greeting.

38. The method of claim 34, wherein the floral product is offered to association members at a price lower than a particular selected corporate event planner business could otherwise obtain for a non-customized version of a similar flower.

39. The method of claim 34 further includes allowing association members to purchase other industry specific items at a bulk discount.
